(19) United States
(12) Patent Application Publication
(10) Pub. No.: US 2026/0160465 A1
(43) Pub. Date: Jun. 11, 2026

(54) SUPERCONDUCTING EQUIPMENT COOLING DEVICE AND OPERATION METHOD FOR SUPERCONDUCTING EQUIPMENT COOLING DEVICE

(71) Applicant: SUMITOMO HEAVY INDUSTRIES, LTD., Tokyo (JP)

(72) Inventors: Takaaki MORIE, Yokosuka-shi, Kanagawa (JP); Takashi HIRAYAMA, Yokosuka-shi, Kanagawa (JP)

(73) Assignee: SUMITOMO HEAVY INDUSTRIES, LTD., Tokyo (JP)

(21) Appl. No.: 18/979,726

(22) Filed: Dec. 13, 2024

Related U.S. Application Data
(63) Continuation of application No. PCT/JP2023/018539, filed on May 18, 2023.

(30) Foreign Application Priority Data
Jun. 15, 2022 (JP) 2022-096472

(51) Int. Cl. F25B 49/02; F25B 9/14; H01F 6/04

(52) U.S. Cl. CPC F25B 49/025; F25B 9/14; H01F 6/04; F25B 2600/0253

(57) ABSTRACT

A superconducting equipment cooling device includes a cryocooler that cools superconducting equipment, an interface configured to receive a selection of a plurality of performance parameters of the cryocooler by a user and generate an operation mode setting representing the selected plurality of performance parameters, and a controller configured to receive the operation mode setting from the interface and control a plurality of operation parameters of the cryocooler that affect the selected plurality of performance parameters.

### CROSS-REFERENCE TO RELATED APPLICATIONS

This is a bypass continuation of International PCT Application No. PCT/JP 2023/018539, filed on May 18, 2023, which claims priority to Japanese Patent Application No. 2022-096472, filed on Jun. 15, 2022, which are incorporated by reference herein in their entirety.

### BACKGROUND

### Technical Field

Certain embodiments of the present invention relate to a superconducting equipment cooling device and an operation method for a superconducting equipment cooling device.

### Description of Related Art

Superconducting equipment such as a superconducting coil needs to be cooled to a cryogenic temperature in order to exhibit superconductivity. A cryocooler is often used for cryogenic cooling of the superconducting equipment.

An existing superconducting equipment cooling device is typically designed to operate under a default operation condition determined by a manufacturer thereof. For this reason, for a user of the superconducting equipment, there is little room for adjusting the operation condition of the superconducting equipment cooling device at user's own discretion.

### SUMMARY

According to an embodiment of the present invention, there is provided a superconducting equipment cooling device including a cryocooler that cools superconducting equipment, an interface configured to receive a selection of a plurality of performance parameters of the cryocooler by a user and generate an operation mode setting representing the selected plurality of performance parameters, and a controller configured to receive the operation mode setting from the interface and control a plurality of operation parameters of the cryocooler that affect the selected plurality of performance parameters.

According to an embodiment of the present invention, there is provided an operation method for a superconducting equipment cooling device. The superconducting equipment cooling device includes a cryocooler that cools superconducting equipment. The method includes receiving a selection of a plurality of performance parameters of the cryocooler by a user, and controlling a plurality of operation parameters of the cryocooler that affect the selected plurality of performance parameters.

According to the present invention, it is possible to improve the usability of the superconducting equipment cooling device.

### BRIEF DESCRIPTION OF THE DRAWINGS

FIG. 1 is a diagram schematically showing a superconducting magnet device according to an embodiment.

FIG. 2 is a diagram schematically showing a cryocooler according to the embodiment.

FIG. 3 is a diagram schematically showing the cryocooler according to the embodiment.

FIG. 4 is a flowchart showing an example of an operation method for a superconducting equipment cooling device according to the embodiment.

FIG. 5 is a flowchart showing an example of a control algorithm used in the operation method for the superconducting equipment cooling device according to the embodiment.

FIGS. 6A and 6B are graphs showing operation frequency dependency of a first-stage temperature and a second-stage temperature of the cryocooler, respectively.

### DETAILED DESCRIPTION

It is desirable to improve usability of a superconducting equipment cooling device.

Hereinafter, embodiments for implementing the present invention will be described in detail with reference to drawings. In the description and drawings, the same reference numerals are assigned to the same or equivalent components, members, and processing, and repeated description is omitted as appropriate. A scale or shape of each part that is shown in the drawings is conveniently set for ease of description and is not limitedly interpreted unless otherwise specified. The embodiments are exemplary and do not limit the scope of the present invention in any way. All features or combinations thereof described in the embodiments are not necessarily essential to the invention.

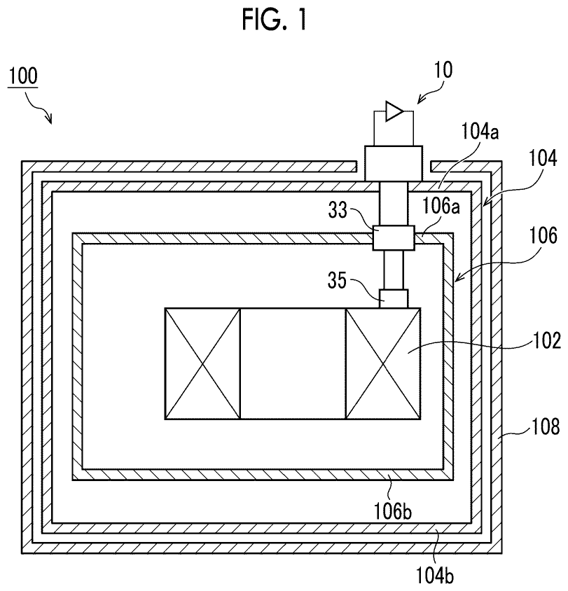

FIG. 1 is a diagram schematically showing superconducting equipment, for example, a superconducting magnet device 100 according to an embodiment. The superconducting magnet device 100 can be mounted on a high magnetic field utilization device as a magnetic field source of, for example, a single crystal pulling-up device, a nuclear magnetic resonance (NMR) system, a magnetic resonance imaging (MRI) system, an accelerator such as a cyclotron, a high energy physics system such as a nuclear fusion system, or another high magnetic field utilization device (not shown) to generate a high magnetic field required for the high magnetic field utilization device.

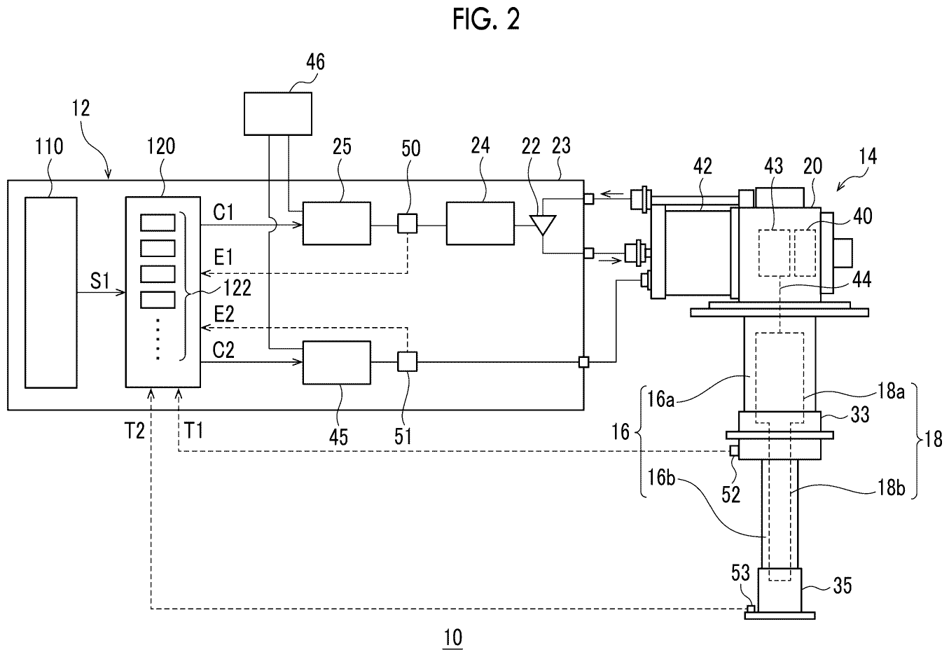

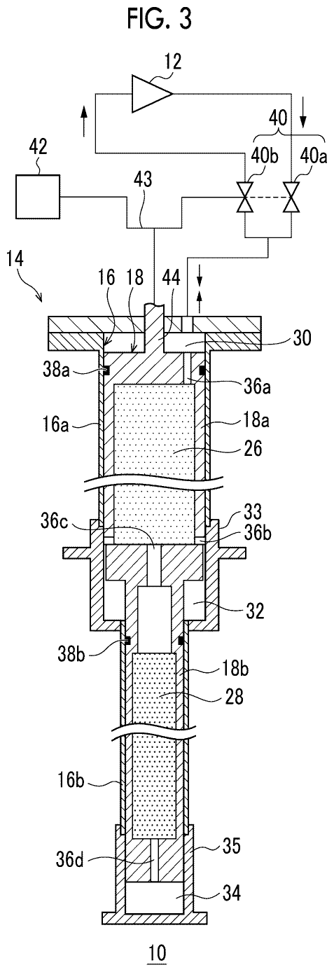

The superconducting magnet device 100 includes a cryocooler 10, a superconducting coil 102, a vacuum chamber 104, a radiation shield 106, and a magnetic shield 108. An exemplary configuration of the cryocooler 10 will be described below with reference to FIGS. 2 and 3.

The superconducting coil 102 is disposed inside the vacuum chamber 104. The superconducting coil 102 is thermally coupled to the cryocooler 10 installed in the vacuum chamber 104, and is used in a state of being cooled to a cryogenic temperature equal to or lower than a superconducting transition temperature. In this embodiment, the superconducting magnet device 100 is configured as a so-called conduction cooling type in which the cryocooler 10 directly cools the superconducting coil 102.

In another embodiment, the superconducting magnet device 100 may be configured as an immersion cooling type in which the superconducting coil 102 is immersed in a cryogenic liquid refrigerant such as liquid helium. In this case, the cryocooler 10 is used for cooling, that is, recondensing of the liquid refrigerant. The cryocooler 10 can cool the superconducting coil 102 via the liquid refrigerant.

The vacuum chamber 104 is a thermally insulated vacuum chamber that provides a cryogenic vacuum environment suitable for bringing the superconducting coil 102 into a superconducting state, and is also referred to as a cryostat. In usual, the vacuum chamber 104 has a columnar shape or a cylindrical shape having a hollow portion at a center portion. Thus, the vacuum chamber 104 has a substantially flat circular or annular top plate 104a and bottom plate 104b, and a cylindrical side wall (cylindrical outer periphery wall, or coaxially disposed cylindrical outer periphery wall and inner periphery wall) that connects the top plate 104a and the bottom plate 104b. The cryocooler 10 may be installed on the top plate 104a of the vacuum chamber 104. The vacuum chamber 104 is formed of, for example, a metal material, such as stainless steel, or another suitable high-strength material to withstand ambient pressure (for example, atmospheric pressure).

The radiation shield 106 is disposed to surround the superconducting coil 102 inside the vacuum chamber 104. The radiation shield 106 has a top plate 106a and a bottom plate 106b that respectively face the top plate 104a and the bottom plate 104b of the vacuum chamber 104. The top plate 106a and the bottom plate 106b of the radiation shield 106 have a substantially flat circular or annular shape, similar to the vacuum chamber 104. Further, the radiation shield 106 has a cylindrical side wall (cylindrical outer periphery wall or coaxially disposed cylindrical outer periphery wall and inner periphery wall) that connects the top plate 106a and the bottom plate 106b. The radiation shield 106 is formed of, for example, pure copper (for example, oxygen-free copper or tough pitch copper), or other high thermal conductivity metal. The radiation shield 106 can block radiant heat from the vacuum chamber 104 and thus thermally protect, from the radiant heat, a low-temperature section such as the superconducting coil 102 disposed on an inner side of the radiation shield 106 and cooled to a lower temperature than the radiation shield 106.

The magnetic shield 108 covers the top plate 104a, the bottom plate 104b, and the cylindrical side wall (at least the outer periphery wall), which connects the top plate 104a and the bottom plate 104b, of the vacuum chamber 104 in order to suppress leakage of the magnetic field generated by the superconducting coil 102 to the outside. The magnetic shield 108 is formed of, for example, a magnetic material such as iron. In this embodiment, the magnetic shield 108 is provided as a member separate from the vacuum chamber 104, and is fixed to an outer side of the vacuum chamber 104. However, in another embodiment, at least a part of the magnetic shield 108 may be integrated with the vacuum chamber 104. For example, at least a part of the top plate 104a, the bottom plate 104b, and the side wall, which connects the top plate 104a and the bottom plate 104b, of the vacuum chamber 104 may be formed of a magnetic material to function as the magnetic shield 108.

A first cooling stage 33 of the cryocooler 10 is thermally coupled to the top plate 106a of the radiation shield 106, and a second cooling stage 35 of the cryocooler 10 is thermally coupled to the superconducting coil 102 on the inner side of the radiation shield 106. During the operation of the superconducting magnet device 100, the radiation shield 106 is cooled to a first cooling temperature, for example, 30 K to 70 K by the first cooling stage 33 of the cryocooler 10, and the superconducting coil 102 is cooled to a second cooling temperature lower than the first cooling temperature, for example, a temperature less than 10 K (for example, about 1 K to about 4 K) by the second cooling stage 35 of the cryocooler 10. The superconducting coil 102 cooled to the cryogenic temperature in this manner can generate a desired high magnetic field by being supplied with electric power from a coil power source (not shown) disposed outside the vacuum chamber 104.

FIGS. 2 and 3 are diagrams schematically showing the cryocooler 10 according to the embodiment. FIG. 2 shows an appearance of the cryocooler 10, and FIG. 3 shows an internal structure of the cryocooler 10. The cryocooler 10 is a two-stage Gifford-McMahon (GM) cryocooler, as an example.

The cryocooler 10 includes a compressor 12 and an expander 14. Although details will be described below, as shown in FIG. 2, an interface 110 and a controller 120 are provided, and these are provided together with the cryocooler 10 to configure a superconducting equipment cooling device according to the embodiment.

The compressor 12 is configured to collect a working gas of the cryocooler 10 from the expander 14, pressurize the collected working gas, and supply the working gas to the expander 14 again. The working gas is also referred to as a refrigerant gas and is typically a helium gas, but other suitable gases may be used.

In general, a pressure of the working gas supplied from the compressor 12 to the expander 14 and a pressure of the working gas collected from the expander 14 to the compressor 12 are considerably higher than the atmospheric pressure, and can be respectively referred to as a first high pressure and a second high pressure. For convenience of description, the first high pressure and the second high pressure are also simply referred to as a high pressure and a low pressure, respectively. Typically, the high pressure is, for example, 2 to 3 MPa. The low pressure is, for example, 0.5 to 1.5 MPa and is, for example, about 0.8 MPa. For the sake of understanding, a flow direction of the working gas is shown by arrows.

The compressor 12 includes a compressor main body 22 and a compressor casing 23 that accommodates the compressor main body 22. The compressor 12 is also referred to as a compressor unit.

The compressor main body 22 is configured to internally compress the working gas sucked from a suction port thereof and to discharge the working gas from a discharge port. The compressor main body 22 may be, for example, a scroll type pump, a rotary type pump, or other pumps that pressurize the working gas. The compressor main body 22 may be configured to discharge the working gas at a fixed and constant flow rate. Alternatively, the compressor main body 22 may be configured to change the flow rate of the working gas to be discharged. The compressor main body 22 may be referred to as a compression capsule.

Further, the compressor 12 includes a compressor motor 24, and a compressor inverter 25 that controls an operation frequency, that is, a rotation speed of the compressor motor 24 based on a compressor control signal C1 from the controller 120. The compressor motor 24 is a drive source that drives the compressor main body 22, and is, for example, an electric motor that is driven by three-phase alternating current. The compressor inverter 25 is configured to convert an alternating current input from a power source 46 to the compressor inverter 25 into an alternating current having a frequency different from the input alternating current, and supply the converted alternating current to the compressor motor 24. The power source 46 may be an external power source such as a commercial power source (three-phase alternating current power source). The operation frequency of the compressor motor 24 may be controlled by the compressor inverter 25 in a range of 30 Hz to 100 Hz or in a range of 40 Hz to 70 Hz.

A first measurer 50 may be provided to measure power consumption of the compressor motor 24. The first measurer 50 may be installed on an electric power supply wire that connects the compressor inverter 25 to the compressor motor 24. As an example, the first measurer 50 may employ, for example, a three-phase power meter based on a two-wattmeter method, or may be another type of electric power sensor that measures the power consumption of the compressor motor 24. The first measurer 50 may be connected to the controller 120 in a communicable manner by wire or wirelessly. A compressor electric power signal E1 indicating the power consumption of the compressor motor 24, which is measured by the first measurer 50, may be input from the first measurer 50 to the controller 120.

The controller 120 may acquire the power consumption of the compressor motor 24 by other known methods. In this case, the cryocooler 10 does not need to include the first measurer 50. For example, the compressor inverter 25 may be configured to measure the power consumption of the compressor motor 24 from a current and a voltage supplied to the compressor motor 24, and the controller 120 may acquire the power consumption of the compressor motor 24 from the compressor inverter 25. Alternatively, the controller 120 may acquire a signal indicating magnitude of the current and the voltage supplied to the compressor motor 24 from the compressor inverter 25 to acquire the power consumption of the compressor motor 24.

As is known, the compressor 12 may have various other components (not shown). For example, an oil separator, an adsorber, or the like may be provided in a working gas flow path on a discharge side. A storage tank or other components may be provided in the working gas flow path on a suction side. Further, the compressor 12 may be provided with an oil circulation system that cools the compressor main body 22 with oil, a cooling system that cools the oil with cooling water, or the like.

The expander 14 includes a cryocooler cylinder 16 and a displacer assembly 18. The cryocooler cylinder 16 guides linear reciprocating motion of the displacer assembly 18, and forms expansion chambers (32, 34) for the working gas with the displacer assembly 18. Further, the expander 14 includes a pressure switching valve 40 that determines a suction start timing of the working gas into the expansion chamber and a discharge start timing of the working gas from the expansion chamber.

In the present specification, in order to describe a positional relationship between the components of the cryocooler 10, for convenience, a side close to a top dead center of axial reciprocation of the displacer is denoted as “upper”, and a side close to a bottom dead center is denoted as “lower”. The top dead center is a position of the displacer where a volume of an expansion space is maximized, and the bottom dead center is a position of the displacer where the volume of the expansion space is minimized. Since a temperature gradient is generated in which a temperature drops from an upper side to a lower side in an axial direction during the operation of the cryocooler 10, the upper side may be referred to as a high temperature side and the lower side may be referred to as a low temperature side.

The cryocooler cylinder 16 includes a first cylinder 16a and a second cylinder 16b. The first cylinder 16a and the second cylinder 16b are members having a cylindrical shape as an example, and the second cylinder 16b has a smaller diameter than the first cylinder 16a. The first cylinder 16a and the second cylinder 16b are coaxially disposed, and a lower end of the first cylinder 16a is rigidly connected to an upper end of the second cylinder 16b.

The displacer assembly 18 includes a first displacer 18a and a second displacer 18b, which are connected to each other and move integrally. The first displacer 18a and the second displacer 18b are members having a cylindrical shape as an example, and the second displacer 18b has a smaller diameter than the first displacer 18a. The first displacer 18a and the second displacer 18b are coaxially disposed.

The first displacer 18a is accommodated in the first cylinder 16a, and the second displacer 18b is accommodated in the second cylinder 16b. The first displacer 18a is reciprocable in the axial direction along the first cylinder 16a, and the second displacer 18b is reciprocable in the axial direction along the second cylinder 16b.

As shown in FIG. 3, the first displacer 18a accommodates a first regenerator 26. The first regenerator 26 is formed by filling a tubular main body of the first displacer 18a with a wire mesh such as copper or other appropriate first regenerator material. An upper lid portion and a lower lid portion of the first displacer 18a may be provided as separate members from the main body of the first displacer 18a, and the upper lid portion and the lower lid portion of the first displacer 18a may be fixed to the main body by appropriate means such as fastening or welding, and thus the first regenerator material may be accommodated in the first displacer 18a.

Similarly, the second displacer 18b accommodates a second regenerator 28. The second regenerator 28 is formed by filling a tubular main body of the second displacer 18b with a non-magnetic regenerator material such as bismuth, a magnetic regenerator material such as HoCu2, or other appropriate second regenerator material. The second regenerator material may be formed in a granular shape. An upper lid portion and a lower lid portion of the second displacer 18b may be provided as separate members from the main body of the second displacer 18b, and the upper lid portion and the lower lid portion of the second displacer 18b may be fixed to the main body by appropriate means such as fastening or welding, and thus the second regenerator material may be accommodated in the second displacer 18b.

The displacer assembly 18 forms a room temperature chamber 30, a first expansion chamber 32, and a second expansion chamber 34 inside the cryocooler cylinder 16. The expander 14 includes the first cooling stage 33 and the second cooling stage 35 for heat exchange with a desired object or medium to be cooled by the cryocooler 10. The room temperature chamber 30 is formed between the upper lid portion of the first displacer 18a and an upper portion of the first cylinder 16a. The first expansion chamber 32 is formed between the lower lid portion of the first displacer 18a and the first cooling stage 33. The second expansion chamber 34 is formed between the lower lid portion of the second displacer 18b and the second cooling stage 35. The first cooling stage 33 is fixed to a lower portion of the first cylinder 16a to surround the first expansion chamber 32, and the second cooling stage 35 is fixed to a lower portion of the second cylinder 16b to surround the second expansion chamber 34. The first cooling stage 33 and the second cooling stage 35 are formed of, for example, pure copper (for example, oxygen-free copper or tough pitch copper) or other high thermal conductivity metal.

The first regenerator 26 is connected to the room temperature chamber 30 through a working gas flow path 36a formed in the upper lid portion of the first displacer 18a, and is connected to the first expansion chamber 32 through a working gas flow path 36b formed in the lower lid portion of the first displacer 18a. The second regenerator 28 is connected to the first regenerator 26 through a working gas flow path 36c formed from the lower lid portion of the first displacer 18a to the upper lid portion of the second displacer 18b. Further, the second regenerator 28 is connected to the second expansion chamber 34 through a working gas flow path 36d formed in the lower lid portion of the second displacer 18b.

A first seal 38a and a second seal 38b may be provided to guide a working gas flow between the first expansion chamber 32, the second expansion chamber 34, and the room temperature chamber 30 into the first regenerator 26 and the second regenerator 28, instead of a clearance between the cryocooler cylinder 16 and the displacer assembly 18. The first seal 38a may be mounted to the upper lid portion of the first displacer 18a to be disposed between the first displacer 18a and the first cylinder 16a. The second seal 38b may be mounted to the upper lid portion of the second displacer 18b to be disposed between the second displacer 18b and the second cylinder 16b.

As shown in FIG. 2, the expander 14 includes a cryocooler housing 20 that accommodates the pressure switching valve 40. The cryocooler housing 20 is coupled to the cryocooler cylinder 16, and thus a hermetic container that accommodates the pressure switching valve 40 and the displacer assembly 18 is formed. The cryocooler housing 20 and the cryocooler cylinder 16 are formed of, for example, a metal material such as stainless steel or other suitable high-strength material to withstand an internal and external pressure difference as the hermetic container.

As shown in FIG. 3, the pressure switching valve 40 includes a high pressure valve 40a and a low pressure valve 40b, and is configured to generate a periodic pressure fluctuation in the cryocooler cylinder 16. A working gas discharge port of the compressor 12 is connected to the room temperature chamber 30 via the high pressure valve 40a, and a working gas suction port of the compressor 12 is connected to the room temperature chamber 30 via the low pressure valve 40b. The high pressure valve 40a and the low pressure valve 40b are configured to be selectively and alternately opened and closed (that is, in a case where one valve is open, the other valve is closed).

The pressure switching valve 40 may have a rotary valve type. That is, the pressure switching valve 40 may be configured such that the high pressure valve 40a and the low pressure valve 40b are alternately opened and closed by rotational sliding of a valve disc with respect to a stationary valve main body. In that case, an expander motor 42 may be connected to the pressure switching valve 40 to cause the valve disc of the pressure switching valve 40 to rotate. For example, the pressure switching valve 40 is disposed such that a valve rotation axis is coaxial with a rotation axis of the expander motor 42.

Alternatively, the high pressure valve 40a and the low pressure valve 40b each may be valves that can be individually controlled. In this case, the pressure switching valve 40 may not be connected to the expander motor 42.

The expander 14 includes the expander motor 42 and a motion conversion mechanism 43. The expander motor 42 is a drive source that drives the expander 14, and is, for example, an electric motor that is driven by the three-phase alternating current. The expander motor 42 is attached to the cryocooler housing 20. The motion conversion mechanism 43 is accommodated in the cryocooler housing 20, similarly to the pressure switching valve 40.

The expander motor 42 is connected to a displacer drive shaft 44 via the motion conversion mechanism 43 such as a Scotch yoke mechanism. The motion conversion mechanism 43 converts rotary motion output by the expander motor 42 into the linear reciprocating motion of the displacer drive shaft 44. The displacer drive shaft 44 extends from the motion conversion mechanism 43 into the room temperature chamber 30, and is fixed to the upper lid portion of the first displacer 18a. The rotation of the expander motor 42 is converted into the axial reciprocation of the displacer drive shaft 44 by the motion conversion mechanism 43, and the displacer assembly 18 reciprocates linearly in the cryocooler cylinder 16 in the axial direction.

Further, the cryocooler 10 is provided with an expander inverter 45 that controls the operation frequency or the rotation speed of the expander motor 42, based on an expander control signal C2 from the controller 120. Although the expander inverter 45 is mounted on the compressor 12 in this example, the present invention is not limited thereto and the expander inverter 45 may be mounted on the expander 14. The expander inverter 45 is configured to convert an alternating current input from the power source 46 to the expander inverter 45 into an alternating current having a frequency different from the input alternating current, and supply the converted alternating current to the expander motor 42. The operation frequency of the expander motor 42 may be controlled by the expander inverter 45 in a range of 30 Hz to 100 Hz or in a range of 40 Hz to 70 Hz.

A second measurer 51 may be provided to measure the power consumption of the expander motor 42. The second measurer 51 may be installed on an electric power supply wire that connects the expander inverter 45 to the expander motor 42. As an example, the second measurer 51 may employ, for example, the three-phase power meter based on the two-wattmeter method, or may be another type of electric power sensor that measures the power consumption of the expander motor 42. The second measurer 51 may be connected to the controller 120 in a communicable manner by wire or wirelessly. An expander electric power signal E2 indicating the power consumption of the expander motor 42 measured by the second measurer 51 may be input from the second measurer 51 to the controller 120.

The controller 120 may acquire the power consumption of the expander motor 42 by other known methods. In this case, the cryocooler 10 does not need to include the second measurer 51. For example, the expander inverter 45 may be configured to measure the power consumption of the expander motor 42 from a current and a voltage supplied to the expander motor 42, and the controller 120 may acquire the power consumption of the expander motor 42 from the expander inverter 45. Alternatively, the controller 120 may acquire a signal indicating magnitude of the current and the voltage supplied to the expander motor 42 from the expander inverter 45 to acquire the power consumption of the expander motor 42.

Further, a first temperature sensor 52 for measuring a temperature of the first cooling stage 33 and a second temperature sensor 53 for measuring a temperature of the second cooling stage 35 may be provided. The first temperature sensor 52 may be attached to the first cooling stage 33. The second temperature sensor 53 may be attached to the second cooling stage 35. The first temperature sensor 52 and the second temperature sensor 53 may be connected to the controller 120 in a communicable manner by wire or wirelessly. A first-stage temperature signal T1 indicating the first cooling temperature measured by the first temperature sensor 52 may be input from the first temperature sensor 52 to the controller 120. A second-stage temperature signal T2 indicating the second cooling temperature measured by the second temperature sensor 53 may be input from the second temperature sensor 53 to the controller 120.

The cryocooler 10 does not necessarily include the first temperature sensor 52 and the second temperature sensor 53. Instead of the attachment of the first temperature sensor 52 and the second temperature sensor 53 to the first cooling stage 33 and the second cooling stage 35, respectively, the first temperature sensor 52 and the second temperature sensor 53 may be provided in the superconducting magnet device 100. In this case, the first temperature sensor 52 may be attached to the radiation shield 106 shown in FIG. 1 and provide the first-stage temperature signal T1 to the controller 120. The second temperature sensor 53 may be attached to the superconducting coil 102 shown in FIG. 1 and provide the second-stage temperature signal T2 to the controller 120.

In the embodiment, the interface 110 for a user to input a setting for controlling the cryocooler 10 to the controller 120 is provided. As an exemplary configuration, the interface 110 may be an operation panel mounted on the compressor 12, or may be attached to the compressor casing 23. The interface 110 is provided with input means, such as an operation button, a keyboard, or a touch screen, which receive the input from the user. Data representing the setting input by the user is transmitted from the interface 110 to the controller 120. Further, the interface 110 may include notification means such as a display, a warning light, or a speaker for presenting, to the user, the setting input by the user or other piece of information related to the cryocooler 10.

As will be described below, the interface 110 may be configured to receive selection of a plurality of performance parameters of the cryocooler 10 from the user and to generate an operation mode setting S1 representing the selected plurality of performance parameters.

The controller 120 is configured to control the cryocooler 10. In the embodiment, as will be described below, the controller 120 may be configured to receive the operation mode setting S1 from the interface 110 and to control a plurality of operation parameters of the cryocooler 10 that affect the selected plurality of performance parameters.

In an internal configuration of the controller 120, a hardware configuration is realized by an element or a circuit including a CPU or a memory of a computer, and a software configuration is realized by a computer program or the like. However, the internal configuration thereof is shown in the drawing as functional blocks realized in cooperation between the hardware configuration and the software configuration as appropriate. Those skilled in the art will understand that these functional blocks can be realized in various forms by a combination of hardware and software.

For example, the controller 120 can be implemented by a combination of a processor (hardware), such as a central processing unit (CPU) or a microcomputer, and a software program executed by the processor (hardware). For example, such a hardware processor may be configured by a programmable logic device such as a field programmable gate array (FPGA), or may be a control circuit such as a programmable logic controller (PLC). The software program may be a computer program for causing the controller 120 to execute the control of the cryocooler 10.

The interface 110 and the controller 120 are not necessarily mounted on the compressor 12 as described above, and another disposition may be employed. For example, the interface 110 and the controller 120 may be mounted on the expander 14. Alternatively, the interface 110 and the controller 120 may be disposed remotely from the cryocooler 10 and may be connected to the cryocooler 10 in a communicable manner.

With the above configuration, in a case where the compressor 12 and the expander motor 42 are operated, the cryocooler 10 generates a periodic volume fluctuation and a pressure fluctuation of the working gas synchronized with the periodic volume fluctuation in the first expansion chamber 32 and the second expansion chamber 34. Typically, in a suction process, with closing of the low pressure valve 40b and opening of the high pressure valve 40a, the high pressure working gas flows from the compressor 12 into the room temperature chamber 30 through the high pressure valve 40a, is supplied to first expansion chamber 32 through the first regenerator 26, and is supplied to the second expansion chamber 34 through the second regenerator 28. In this manner, the first expansion chamber 32 and the second expansion chamber 34 are pressurized from the low pressure to the high pressure. In this case, the displacer assembly 18 is moved upward from the bottom dead center to the top dead center, and the volumes of the first expansion chamber 32 and the second expansion chamber 34 are increased. In a case where the high pressure valve 40a is closed, the suction process ends.

In a discharge process, with closing of the high pressure valve 40a and opening of the low pressure valve 40b, the high pressure first expansion chamber 32 and the second expansion chamber 34 are opened to the low pressure working gas suction port of the compressor 12. Thus, the working gas expands in the first expansion chamber 32 and the second expansion chamber 34, and the working gas, which is brought into low pressure as a result, is discharged from the first expansion chamber 32 and the second expansion chamber 34 to the room temperature chamber 30 through the first regenerator 26 and the second regenerator 28. In this case, the displacer assembly 18 is moved downward from the top dead center to the bottom dead center, and the volumes of the first expansion chamber 32 and the second expansion chamber 34 are reduced. The working gas is collected from the expander 14 to the compressor 12 through the low pressure valve 40b. In a case where the low pressure valve 40b is closed, the discharge process ends.

In this manner, for example, a refrigeration cycle such as a GM cycle is configured, and the first cooling stage 33 and the second cooling stage 35 are cooled to a desired cryogenic temperature. The first cooling stage 33 can be cooled to the first cooling temperature in a range of, for example, about 30 K to about 70 K. The second cooling stage 35 can be cooled to the second cooling temperature (for example, about 1 K to about 4 K) lower than the first cooling temperature. Therefore, it is possible to cool the superconducting coil 102 to a temperature equal to or lower than a critical temperature, and to cause the superconducting magnet device 100 to operate.

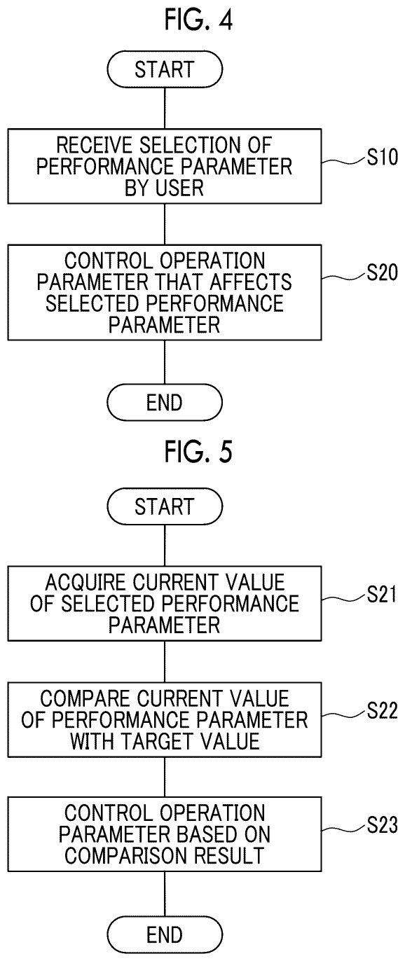

FIG. 4 is a flowchart showing an example of an operation method for the superconducting equipment cooling device according to the embodiment. The method includes a step (S10) of receiving the selection of the plurality of performance parameters of the cryocooler 10 by the user via the interface 110, and a step (S20) of controlling the plurality of operation parameters of the cryocooler 10 that affect the selected plurality of performance parameters by the controller 120.

The interface 110 may be configured to present, to the user, various performance parameters of the cryocooler 10 as selection candidates. For example, the interface 110 may display the performance parameters of the candidates on the display. The user refers to such a display to select, on the interface 110, the performance parameter in which the user is interested, and thus the selection of the performance parameter can be input to the interface 110.

The plurality of performance parameters of the cryocooler 10 presented to the user may be at least three parameters representing performance of the cryocooler 10. The at least three parameters may include a first-stage temperature of the cryocooler 10, a second-stage temperature of the cryocooler 10, and the power consumption of the cryocooler 10.

The first-stage temperature, the second-stage temperature, and the power consumption of the cryocooler 10 affect the operation of the superconducting equipment cooled by the cryocooler 10, and thus are representative performance parameters of the cryocooler 10 in which the user is highly interested.

The interface 110 may be configured to receive the selection of two performance parameters at maximum from among the selectable performance parameter candidates. The selected performance parameter may be one or two performance parameters of the first-stage temperature of the cryocooler 10, the second-stage temperature of the cryocooler 10, and the power consumption of the cryocooler 10.

The selection of the plurality of performance parameters of the cryocooler 10 by the user may include prioritization of the performance parameters. Thus, the selected plurality of performance parameters may include a first performance parameter having a first priority and a second performance parameter having a second priority. The first priority and the second priority are based on the prioritization by the user. The first priority represents a higher priority than the second priority. The controller 120 may be configured to control the plurality of operation parameters to preferentially improve the first performance parameter as compared with the second performance parameter.

In a case where two performance parameters at maximum are selected with the prioritization, the interface 110 may generate nine different operation mode settings S1. That is, in a case where only one performance parameter is selected, there are the following three patterns (operation modes 1 to 3). In a case where two performance parameters are selected with the prioritization, there are the following six patterns (operation modes 4 to 9). In the following, the operation modes 4 to 9 are described in a high-priority order, that is, in an order of the first performance parameter having the first priority and the second performance parameter having the second priority from the left.
Operation mode 1: second-stage temperature
Operation mode 2: first-stage temperature
Operation mode 3: power consumption
Operation mode 4: second-stage temperature, first-stage temperature
Operation mode 5: first-stage temperature, second-stage temperature
Operation mode 6: second-stage temperature, power consumption
Operation mode 7: power consumption, second-stage temperature
Operation mode 8: first-stage temperature, power consumption
Operation mode 9: power consumption, first-stage temperature

Instead of the presentation of the performance parameter itself to the user as the selection candidate, the interface 110 may present all or a part of the operation modes 1 to 9 to the user as the selection candidate.

For convenience of selection, names may be assigned to the operation modes in advance, and the interface 110 may present such operation mode names for selection. For example, the operation mode names such as a power consumption mode 1, a power consumption mode 2, and a power consumption mode 3 may be respectively assigned to the operation modes 3, 7, and 9 in which the power consumption is prioritized (or in a case where the superconducting magnet device 100 is an MRI device, since reduction in the power consumption may be prioritized for the user in nighttime operation compared with daytime operation, the operation modes may be named as a nighttime mode 1, a nighttime mode 2, and a nighttime mode 3).

The operation mode 4 may be named a standard operation mode. The operation mode 1 and the operation mode 6 may be respectively named an emergency mode 1 and an emergency mode 2. In the operation mode 1, only maintenance of the second-stage temperature is prioritized. Thus, in a situation where quenching (disappearance of superconductivity) may occur, the operation mode 1 may be helpful in delaying occurrence of the quenching. In the operation mode 6, the maintenance of the second-stage temperature is most prioritized, and the power consumption is secondarily prioritized. Thus, in a situation where the superconducting equipment is operated by an auxiliary power source for a power failure countermeasure, the operation mode 6 may be helpful in making the auxiliary power source last longer. The operation mode 5 in which the maintenance of the first-stage temperature is prioritized may be named an aging deterioration countermeasure mode. Since aging deterioration of the cryocooler 10 often appears as the first-stage temperature rises, the operation mode 5 may be useful in reducing the influence of the aging deterioration.

The interface 110 may be configured to receive, for a selected performance parameter, a target value of the performance parameter from the user.

Accordingly, the user can set the target value to be satisfied by the performance parameter in addition to the selection of the performance parameter. The operation mode setting S1 may include the target value of the performance parameter set by the user.

As shown in FIG. 2, in a case where the selection of the plurality of performance parameters of the cryocooler 10 by the user is received, the interface 110 generates the operation mode setting S1 representing the selected plurality of performance parameters and outputs the generated operation mode setting S1 to the controller 120. The operation mode setting S1 is stored in the controller 120.

The controller 120 may include a plurality of control algorithms 122 respectively corresponding to the different operation mode settings S1 (for example, the controller 120 may include nine control algorithms 122 respectively corresponding to the operation modes 1 to 9). Each control algorithm 122 may be configured to control the plurality of operation parameters of the cryocooler 10 to improve at least one performance parameter of the plurality of performance parameters selected in a corresponding operation mode setting S1.

Therefore, the controller 120 may be configured to receive the operation mode setting S1 from the interface 110, select the control algorithm 122 corresponding to the operation mode setting S1 from the plurality of control algorithms 122, and control the plurality of operation parameters of the cryocooler 10 according to the selected control algorithm 122.

FIG. 5 is a flowchart showing an example of the control algorithm 122 used in the operation method for the superconducting equipment cooling device according to the embodiment. The control algorithm 122 is executed in a step (S20 in FIG. 4) of controlling the plurality of operation parameters of the cryocooler 10. As shown in the drawing, the control algorithm 122 includes a step (S21) of acquiring a current value of the performance parameter selected in the corresponding operation mode setting S1, a step (S22) of comparing the acquired current value of the performance parameter with the target value, and a step (S23) of controlling the operation parameter of the cryocooler 10 based on a comparison result.

In a case where the selected performance parameter is the first-stage temperature of the cryocooler 10, the controller 120 can acquire the current value of the first-stage temperature from the first-stage temperature signal T1 from the first temperature sensor 52. Similarly, in a case where the selected performance parameter is the second-stage temperature of the cryocooler 10, the controller 120 can acquire the current value of the second-stage temperature from the second-stage temperature signal T2 from the second temperature sensor 53.

In a case where the selected performance parameter is the power consumption of the cryocooler 10, the controller 120 can acquire the current value of the power consumption of the cryocooler 10 from the compressor electric power signal E1 from the first measurer 50 and the expander electric power signal E2 from the second measurer 51. The power consumption of the cryocooler 10 can be obtained as a sum of the power consumption of the compressor motor 24 and the power consumption of the expander motor 42. As described above, the controller 120 may acquire the current and the voltage supplied to each of the compressor motor 24 and the expander motor 42, and calculate the power consumption of the cryocooler 10 from the acquired current and voltage.

The target value of the performance parameter to be compared with the acquired current value of the performance parameter may be a value set by the user as described above. Alternatively, in a case where the target value is not set by the user, the controller 120 may use a default target value for the individual performance parameter or the target value set by the controller 120.

The controller 120 compares the acquired current value of the performance parameter with the target value to generate the comparison result. The comparison result can take any one of three states of a state A, a state B, and a state C below depending on a magnitude relationship between the current value and the target value.
State A: The current value is smaller (lower) than the target value.
State B: The current value is equal to the target value.
State C: The current value is larger (higher) than the target value.

The “current value is equal to the target value” in the state B may include not only a case where the current value strictly matches the target value but also a case where the current value is within an allowable range including the target value. The allowable range may be a range of a predetermined ratio or a predetermined amount (for example, within ±5% of the target value) to the target value. The state A (or state C) may represent that the current value exceeds the allowable range (or does not satisfy the allowable range).

In a case where the selected performance parameter is the first-stage temperature, the second-stage temperature, or the power consumption of the cryocooler 10, the performance parameter can be regarded as satisfying the target value in a case of the comparison result of the state A or the state B. On the other hand, in a case of the comparison result of the state C, the performance parameter is regarded as not satisfying the target value.

The controller 120 may operate the interface 110 based on the comparison result to present, to the user, information indicating that the performance parameter satisfies the target value or to present information (that is, warning) indicating that the performance parameter does not satisfy the target value. For example, the controller 120 may light the warning light provided on the interface 110 to warn the user.

Together with the presentation of the information to the user, or instead of the presentation of the information to the user, the controller 120 may control the operation parameter of the cryocooler 10 to reduce a deviation between the acquired current value and the target value of the performance parameter. For example, in a case where the acquired current value of the performance parameter does not satisfy the target value (that is, in a case where the comparison result is the state C), the controller 120 may control the operation parameter of the cryocooler 10 such that the value of the performance parameter is changed toward the target value (for example, the value of the performance parameter is reduced).

The controller 120 may select at least one of the plurality of operation parameters of the cryocooler 10 based on the comparison result, and control the selected operation parameter. In this case, the control algorithm 122 may define in advance the operation parameter to be controlled according to the comparison result (that is, for each of the plurality of states). Therefore, the controller 120 can select the operation parameter of a control target with reference to the comparison result.

The controller 120 may be configured to determine the value of the operation parameter of the control target. The controller 120 may add a certain change amount to the current value of the operation parameter to determine a new value of the operation parameter. The change amount may be a positive or negative value, and thus the value of the operation parameter may be increased or decreased. The change amount may be a fixed value or may be a variable value changed according to a situation.

The operation parameter of the cryocooler 10 is an operable parameter that affects the performance parameter of the cryocooler 10, and may be, for example, the operation frequency of the compressor motor 24 or the operation frequency of the expander motor 42.

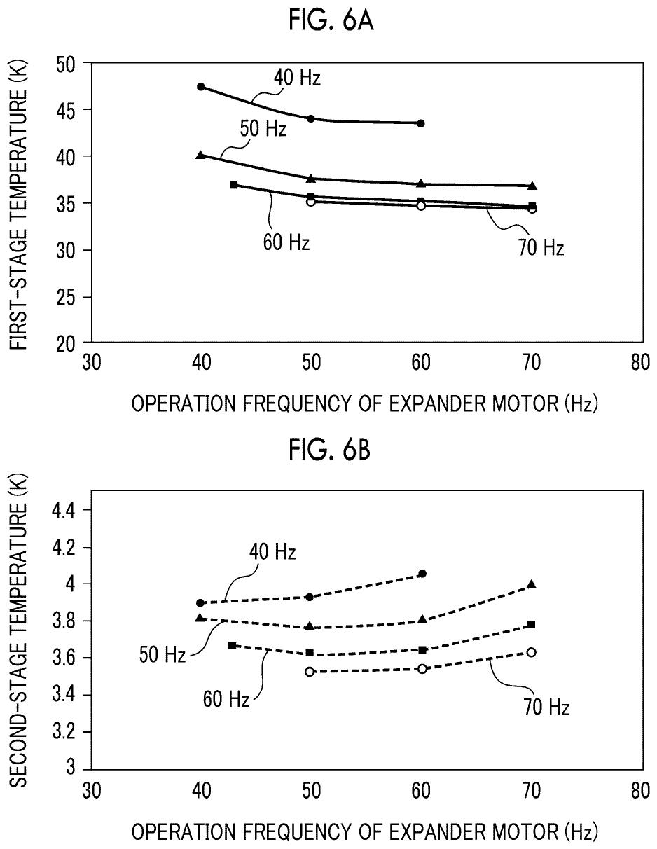

FIG. 6A shows a relationship between the first-stage temperature and the operation frequency of the expander motor 42 for each of four cases of 40 Hz, 50 Hz, 60 Hz, and 70 Hz in the operation frequency of the compressor motor 24. The first-stage temperature of the cryocooler 10 tends to monotonously decrease as the operation frequency of the compressor motor 24 increases, as shown in FIG. 6A. Thus, with the change (for example, increase) in the operation frequency of the compressor motor 24, it is possible to adjust (for example, decrease) the first-stage temperature.

Similarly, the first-stage temperature tends to monotonously decrease as the operation frequency of the expander motor 42 increases. With the change (for example, increase) in the operation frequency of the expander motor 42, it is possible to adjust (for example, decrease) the first-stage temperature.

Typically, the first-stage temperature may be more greatly adjusted in a case where the operation frequency of the compressor motor 24 is changed by the same magnitude than in a case where the operation frequency of the expander motor 42 is changed by certain magnitude. As understood from FIG. 6A, such a tendency is remarkable in a case where the operation frequency of the compressor motor 24 is 60 Hz or less. Therefore, in a case where the first-stage temperature of the cryocooler 10 is selected as the performance parameter in the operation mode setting S1, it may be more effective to select the operation frequency of the compressor motor 24 as the operation parameter.

FIG. 6B shows a relationship between the second-stage temperature and the operation frequency of the expander motor 42 for each of four cases of 40 Hz, 50 Hz, 60 Hz, and 70 Hz in the operation frequency of the compressor motor 24. The second-stage temperature of the cryocooler 10 tends to monotonously decrease as the operation frequency of the compressor motor 24 increases, as shown in FIG. 6B. Thus, with the change (for example, increase) in the operation frequency of the compressor motor 24, it is possible to adjust (for example, decrease) the second-stage temperature.

On the other hand, the second-stage temperature has a tendency different from that of the first-stage temperature for the operation frequency of the expander motor 42. Specifically, in a case where the operation frequency of the expander motor 42 is changed with the operation frequency of the compressor motor 24 being constant, the second-stage temperature is the lowest in a case where the operation frequency of the expander motor 42 takes a certain value (for example, as shown in FIG. 6B, in a case where the operation frequency of the compressor motor 24 is 50 Hz, the second-stage temperature is the lowest in a case where the operation frequency of the expander motor 42 is 50 Hz). In other words, in a case where the operation frequency of the expander motor 42 is smaller than this value, the second-stage temperature decreases as the operation frequency of the expander motor 42 increases. However, in a case where the operation frequency of the expander motor 42 is larger than this value, the second-stage temperature increases as the operation frequency of the expander motor 42 increases. Therefore, it cannot be said unconditionally whether the increase or the decrease in the operation frequency of the expander motor 42 is required to decrease the second-stage temperature. Such operation frequency dependency of the second-stage temperature remarkably appears in a case where the second-stage temperature is about 4 K or less.

Therefore, in a case where the second-stage temperature of the cryocooler 10 is selected as the performance parameter in the operation mode setting S1, it is desirable to control both the operation frequency of the compressor motor 24 and the operation frequency of the expander motor 42, as the operation parameters, in order to further decrease the second-stage temperature.

The power consumption of the cryocooler 10 is basically in a trade-off relationship with the cooling temperature. The power consumption tends to monotonically increase as the operation frequency of the compressor motor 24 increases. Thus, with the change (for example, decrease) in the operation frequency of the compressor motor 24, it is possible to adjust (for example, decrease) the power consumption. Further, the power consumption may be increased or decreased by the change in the operation frequency of the expander motor 42. Thus, with the change in the operation frequency of the expander motor 42, it is possible to adjust the power consumption. In a case where the power consumption of the cryocooler 10 is selected as the performance parameter in the operation mode setting S1, it may be more effective to select the operation frequency of the compressor motor 24 as the operation parameter.

In a case where the operation frequency of the compressor motor 24 is controlled, the controller 120 generates a compressor control signal C1 representing the determined value of the operation frequency of the compressor motor 24, and transmits the compressor control signal C1 to the compressor inverter 25. The compressor inverter 25 receives the compressor control signal C1 and operates to drive the compressor motor 24 at the determined operation frequency.

Similarly, in a case where the operation frequency of the expander motor 42 is controlled, the controller 120 generates the expander control signal C2 representing the determined value of the operation frequency of the expander motor 42, and transmits the expander control signal C2 to the expander inverter 45. The expander inverter 45 receives the expander control signal C2 and operates to drive the expander motor 42 at the determined operation frequency.

Since it takes some time until the influence of the operation parameter change appears in the performance parameter, the controller 120 may wait for a predetermined time after the operation parameter is changed. In a case where the waiting time has elapsed, the controller 120 may execute the control algorithm 122 (S21 to S23) again.

In a case where two performance parameters are selected in the operation mode setting S1, the controller 120 acquires the current value of the first performance parameter and the current value of the second performance parameter to compare the current value of the first performance parameter with a first target value and to compare the current value of the second performance parameter with a second target value. The first target value and the second target value are respectively target values of the first performance parameter and the second performance parameter. In a case where the prioritization of the performance parameters is included in the operation mode setting S1, as described above, the first performance parameter may have the first priority and the second performance parameter may have the second priority. A comparison result may take any of nine states from a state Aa to a state Cc described below.
State Aa: The current value of the first performance parameter is smaller than the first target value, and the current value of the second performance parameter is smaller than the second target value.
State Ab: The current value of the first performance parameter is smaller than the first target value, and the current value of the second performance parameter is equal to the second target value.
State Ac: The current value of the first performance parameter is smaller than the first target value, and the current value of the second performance parameter is larger than the second target value.
State Ba: The current value of the first performance parameter is equal to the first target value, and the current value of the second performance parameter is smaller than the second target value.
State Bb: The current value of the first performance parameter is equal to the first target value, and the current value of the second performance parameter is equal to the second target value.
State Bc: The current value of the first performance parameter is equal to the first target value, and the current value of the second performance parameter is larger than the second target value.
State Ca: The current value of the first performance parameter is larger than the first target value, and the current value of the second performance parameter is smaller than the second target value.
State Cb: The current value of the first performance parameter is larger than the first target value, and the current value of the second performance parameter is equal to the second target value.
State Cc: The current value of the first performance parameter is larger than the first target value, and the current value of the second performance parameter is larger than the second target value.

The controller 120 may operate the interface 110 based on the comparison result to present, to the user, information representing whether or not the performance parameter satisfies the target value. For example, in a case where the first performance parameter does not satisfy the first target value, the controller 120 may issue a first warning, regardless of whether or not the second performance parameter satisfies the second target value (states Ca, Cb, and Cc). With the above, the user can be reliably notified that the first performance parameter having a higher priority than the second performance parameter does not satisfy the target value thereof. In a case where the first performance parameter satisfies the first target value and the second performance parameter does not satisfy the second target value, the controller 120 may issue a second warning (states Ac and Bc). Further, in a case where the first performance parameter satisfies the first target value and the second performance parameter satisfies the second target value, the controller 120 may issue a normal notification. The first warning, the second warning, and the normal notification may be presented to the user via the interface 110.

Together with the presentation of the information to the user, or instead of the presentation of the information to the user, the controller 120 may control the plurality of operation parameters of the cryocooler 10 to preferentially improve the first performance parameter as compared with the second performance parameter. In this case, the controller 120 may control, in a case where the first performance parameter does not satisfy the first target value, the first operation parameter that affects the first performance parameter among the plurality of operation parameters, regardless of whether or not the second performance parameter satisfies the second target value. The first operation parameter may be controlled to reduce a deviation between the current value of the first performance parameter and the first target value.

In a case where the first performance parameter satisfies the first target value and the second performance parameter does not satisfy the second target value, the controller 120 may control the second operation parameter that affects the second performance parameter among the plurality of operation parameters. The second operation parameter may be controlled to reduce a deviation between the current value of the second performance parameter and the second target value. The second operation parameter may be different from the first operation parameter. The first operation parameter may be the operation frequency of the compressor motor 24 (or the operation frequency of the expander motor 42), and the second operation parameter may be the operation frequency of the expander motor 42 (or the operation frequency of the compressor motor 24).

Several examples of the control algorithm 122 will be described. A first example is the operation mode 4 (case where the first performance parameter is the second-stage temperature and the second performance parameter is the first-stage temperature). In an example of the control algorithm 122 corresponding to the operation mode 4, the operation parameter is controlled as follows for each of nine states from a state Aa to a state Cc.
State Aa: The operation parameter is maintained.
State Ab: The operation parameter is maintained.
State Ac: The operation frequency of the compressor motor 24 is increased.
State Ba: The operation parameter is maintained.
State Bb: The operation parameter is maintained.
State Bc: The operation frequency of the compressor motor 24 is increased.
State Ca: The operation frequency of the expander motor 42 is changed.
State Cb: The operation frequency of the expander motor 42 is changed.
State Cc: The operation frequency of the compressor motor 24 is increased.

In the six states from the state Aa to the state Bc, the second-stage temperature, which is the first performance parameter, satisfies the target value thereof. Since the first-stage temperature, which is the second performance parameter, also satisfies the target value in the states Aa, Ab, Ba, and Bb among the six states, there is no need to change the operation parameter, and the operation parameter is maintained.

In the states Ac and Bc, the operation parameter is controlled such that the first-stage temperature, which is the second performance parameter, satisfies the target value while the second-stage temperature, which is the first performance parameter, satisfies the target value. In the state Ac, it is expected that the first-stage temperature (and the second-stage temperature) decreases as a result of the increase in the operation frequency of the compressor motor 24 and transition to the state Ab is performed. In a case where the operation frequency of the compressor motor 24 has already reached a highest value in an adjustable range (for example, 70 Hz), the operation frequency of the expander motor 42 may be increased, instead of the increase in the operation frequency of the compressor motor 24 (In this case, transition to the state Ab or the state Bb is expected to be performed. In an event that transition to the state Cb is performed, a warning is issued.). Further, in the state Bc, it is expected that the first-stage temperature (and the second-stage temperature) decreases as a result of the increase in the operation frequency of the compressor motor 24 and transition to the state Ab or the state Ac is performed.

In the states Ca to Cc, the operation parameter is controlled such that the second-stage temperature, which is the first performance parameter, satisfies the target value. In the states Ca and Cb, it is expected that the operation frequency of the expander motor 42 is increased (or decreased) and transition to any one of the states Ba to Bc is performed as a result of the increase (or decrease) in the operation frequency of the expander motor 42. In a case where the state Ca is maintained in spite of the optimization of the operation frequency of the expander motor 42, the operation frequency of the compressor motor 24 may be increased (In this case, the transition to any one of the states Ba to Bc is expected to be performed. In an event that the state Ca is still maintained, a warning is issued.). The state Cc is expected to transition to the state Bc or Cb as a result of the increase in the operation frequency of the compressor motor 24. Even in a case where the state Cc is maintained, the operation frequency of the expander motor 42 may be decreased (In this case, transition to the state Bc is expected to be performed. In an event that the state Cc is still maintained, a warning is issued.).

A second example is the operation mode 6 (case where the first performance parameter is the second-stage temperature and the second performance parameter is the power consumption). In an example of the control algorithm 122 corresponding to the operation mode 6, the operation parameter is controlled as follows for each of the nine states from the state Aa to the state Cc.
State Aa: The operation parameter is maintained.
State Ab: The operation parameter is maintained.
State Ac: The operation frequency of the compressor motor 24 is decreased.
State Ba: The operation parameter is maintained.
State Bb: The operation parameter is maintained.
State Bc: The operation frequency of the expander motor 42 is changed.
State Ca: The operation frequency of the compressor motor 24 is increased.
State Cb: The operation frequency of the compressor motor 24 is increased.
State Cc: The operation frequency of the compressor motor 24 is increased.

In the six states from the state Aa to the state Bc, the second-stage temperature, which is the first performance parameter, satisfies the target value thereof. Since the power consumption, which is the second performance parameter, also satisfies the target value in the states Aa, Ab, Ba, and Bb among the six states, there is no need to change the operation parameter, and the operation parameter is maintained. In the states Aa and Ab, with the decrease in the operation frequency of the compressor motor 24, the power consumption may be further reduced (in this case, transition to the state Ba may be performed).

In the states Ac and Bc, the operation parameter is controlled such that the power consumption, which is the second performance parameter, satisfies the target value while the second-stage temperature, which is the first performance parameter, satisfies the target value. The state Ac is expected to transition to the state Ab or Bb as a result of the decrease in the operation frequency of the compressor motor 24. The state Bc is expected to transition to the state Ab or Bb as a result of the change in the operation frequency of the expander motor 42 (in an event that the state Bc is still maintained, a warning is issued.).

In the states Ca to Cc, the operation parameter is controlled such that the second-stage temperature, which is the first performance parameter, satisfies the target value. The state Ca may transition to the state Ba or Cb as a result of the increase in the operation frequency of the compressor motor 24. The state Cb may transition to the state Bc or Cc as a result of the increase in the operation frequency of the compressor motor 24. The state Cc may transition to the state Bc as a result of the increase in the operation frequency of the compressor motor 24 (In a case where the transition is not performed, with the change in the operation frequency of the expander motor 42, transition to the state Bc may be performed. In an event that the state Cc is still maintained, a warning is issued.).

A third example is the operation mode 7 (case where the first performance parameter is power consumption and the second performance parameter is the second-stage temperature). In an example of the control algorithm 122 corresponding to the operation mode 7, the operation parameter is controlled as follows for each of the nine states from the state aa to the state Cc.
State Aa: The operation parameter is maintained.
State Ab: The operation parameter is maintained.
State Ac: The operation frequency of the expander motor 42 is changed.
State Ba: The operation parameter is maintained.
State Bb: The operation parameter is maintained.
State Bc: The operation frequency of the expander motor 42 is changed.
State Ca: The operation frequency of the compressor motor 24 is decreased.
State Cb: The operation frequency of the compressor motor 24 is decreased.
State Cc: The operation frequency of the compressor motor 24 is decreased.

In the six states from the state Aa to the state Bc, the power consumption, which is the first performance parameter, satisfies the target value. Since the second-stage temperature, which is the second performance parameter, also satisfies the target value in the states Aa, Ab, Ba, and Bb among the six states, there is no need to change the operation parameter, and the operation parameter is maintained. In the state Aa, with the decrease in the operation frequency of the compressor motor 24, the power consumption may be further reduced (in this case, transition to the state Ab may be performed).

In the states Ac and Bc, the operation parameter is controlled such that the second-stage temperature, which is the second performance parameter, satisfies the target value while the power consumption, which is the first performance parameter, satisfies the target value. In the state Ac, it is expected that the operation frequency of the expander motor 42 is increased (or decreased) and transition to the state Ab or Bc is performed as a result of the increase (or decrease) in the operation frequency of the expander motor 42. In a case where the state Ac is maintained in spite of the optimization of the operation frequency of the expander motor 42, the operation frequency of the compressor motor 24 may be increased and transition to the state Ab or Bc may be performed. In the state Bc, it is expected that the operation frequency of the expander motor 42 is increased (or decreased) and transition to the state Ab or Bb is performed as a result of the increase (or decrease) in the operation frequency of the expander motor 42 (in an event that the state Bc is still maintained, a warning is issued.).

In the states Ca to Cc, the operation parameter is controlled such that the power consumption, which is the first performance parameter, satisfies the target value. The state Ca may transition to the state Ba or Cb as a result of the decrease in the operation frequency of the compressor motor 24. The state Cb may transition to the state Bb or Bc as a result of the decrease in the operation frequency of the compressor motor 24. The state Cc may transition to the state Bc as a result of the decrease in the operation frequency of the compressor motor 24.

As described at the beginning of the present specification, the existing superconducting equipment cooling device is often operated under a default operation condition determined by the manufacturer thereof. For example, the cooling device may be operated with a sufficient margin in cooling capacity. In this case, it is advantageous to enable a stable operation of the superconducting equipment even in a case where various assumed emergencies or other unforeseen events occur. However, for the user of the superconducting equipment, there is little room for adjusting the operation condition of the cooling device at user's own discretion, for example, from another viewpoint such as energy saving.

On the contrary, with the superconducting equipment cooling device according to the embodiment, the user itself can select the performance parameter of the cryocooler 10 itself in order to realize an operation state that the user considers to be desirable. In the cryocooler 10, the operation parameter is controlled such that the selected performance parameter satisfies the target value, and thus the operation state desired by the user can be realized. Further, in a case where such a desirable operation state is not realized, the user can be notified of the fact by a warning. Therefore, it is possible to improve usability of the superconducting equipment cooling device.

The present invention has been described above based on the examples. It is understood by those skilled in the art that the present invention is not limited to the above embodiments, various design changes can be made, various modification examples are possible, and such modification examples are also within the scope of the present invention. Various features described in relation to an embodiment are also applicable to other embodiments. A new embodiment resulting from a combination has the effect of each of the embodiments which are combined.

In the above embodiment, the first-stage temperature, the second-stage temperature, and the power consumption are exemplified as the performance parameter of the cryocooler 10. However, other performance parameters may be used. For example, in a case where the superconducting magnet device 100 is of the immersion cooling type, a pressure of a liquid refrigerant tank (for example, liquid helium tank) in the vacuum chamber 104 may be used as the performance parameter. Since the liquid refrigerant of the liquid refrigerant tank is cooled in the second cooling stage 35, the pressure of the liquid refrigerant tank correlates with the second-stage temperature. Thus, it is possible to use the pressure of the liquid refrigerant tank as the performance parameter, instead of the second-stage temperature.

In the above embodiment, the operation frequencies of the compressor motor 24 and the expander motor 42 are exemplified as the operation parameters of the cryocooler 10. However, other operation parameters may be used. For example, in a case where a first heater for heating the first cooling stage 33 and/or a second heater for heating the second cooling stage 35 is provided, an output of the heater may be used as the operation parameter.

In the above embodiment, the two-stage GM cryocooler has been described as an example. However, the present invention is not limited thereto. In a certain embodiment, the cryocooler 10 may be a single-stage GM cryocooler. In a certain embodiment, the cryocooler 10 may be another type of cryocooler, such as a Solvay cryocooler, a Stirling cryocooler, or a pulse tube cryocooler.

In the above embodiment, a case where the cryocooler 10 cools the superconducting magnet device 100 has been described as an example. However, the present invention is not limited thereto. In a certain embodiment, the cryocooler 10 may provide cryogenic cooling for another piece of superconducting equipment, such as equipment for electric power transmission using superconductivity or sensor equipment using superconductivity.

Although the present invention has been described using specific words and phrases based on the embodiment, the embodiment merely shows one aspect of the principle and application of the present invention, and various modifications and disposition changes can be made without departing from the scope of the present invention described in claims.

The present invention can be used in fields of a superconducting equipment cooling device and an operation method for a superconducting equipment cooling device.

It should be understood that the invention is not limited to the above-described embodiment, but may be modified into various forms on the basis of the spirit of the invention. Additionally, the modifications are included in the scope of the invention.

What is claimed is:

1. A superconducting equipment cooling device comprising:
a cryocooler that cools superconducting equipment;
an interface configured to receive a selection of a plurality of performance parameters of the cryocooler by a user, and generate an operation mode setting representing the selected plurality of performance parameters; and
a controller configured to receive the operation mode setting from the interface and control a plurality of operation parameters of the cryocooler that affect the selected plurality of performance parameters.

2. The superconducting equipment cooling device according to claim 1,
wherein the operation mode setting includes prioritization of the plurality of performance parameters of the cryocooler by the user,
the selected plurality of performance parameters includes a first performance parameter having a first priority and a second performance parameter having a second priority, based on the prioritization,
the first priority represents a higher priority than the second priority, and
the controller is configured to control the plurality of operation parameters to preferentially improve the first performance parameter compared with the second performance parameter.

3. The superconducting equipment cooling device according to claim 2,
wherein the controller is configured to:
compare a current value of the first performance parameter with a first target value, and
control a first operation parameter that affects the first performance parameter, among the plurality of operation parameters, when the first performance parameter does not satisfy the first target value, regardless of whether or not the second performance parameter satisfies a second target value.

4. The superconducting equipment cooling device according to claim 3,
wherein the controller is configured to:
compare a current value of the second performance parameter with the second target value, and
control a second operation parameter that affects the second performance parameter, among the plurality of operation parameters, when the first performance parameter satisfies the first target value and the second performance parameter does not satisfy the second target value.

5. The superconducting equipment cooling device according to claim 4,
wherein the controller is configured to:
issue a first warning, when the first performance parameter does not satisfy the first target value, regardless of whether or not the second performance parameter satisfies the second target value, and
issue a second warning, when the first performance parameter satisfies the first target value and the second performance parameter does not satisfy the second target value.

6. The superconducting equipment cooling device according to claim 1,
wherein the controller includes a plurality of control algorithms respectively corresponding to different operation mode settings, and
each control algorithm is configured to control the plurality of operation parameters to improve at least one performance parameter, among the plurality of performance parameters, selected in a corresponding operation mode setting.

7. The superconducting equipment cooling device according to claim 1,
wherein the selected plurality of performance parameters are two performance parameters among a first-stage temperature of the cryocooler, a second-stage temperature of the cryocooler, and power consumption of the cryocooler.

8. The superconducting equipment cooling device according to claim 1,
wherein the cryocooler includes an expander and a compressor that supplies a refrigerant gas to the expander,
the expander includes an expander motor that drives the expander and an expander inverter that controls an operation frequency of the expander motor,
the compressor includes a compressor motor that drives the compressor and a compressor inverter that controls an operation frequency of the compressor motor, and
the plurality of operation parameters include the operation frequency of the compressor motor and the operation frequency of the expander motor.

9. An operation method for a superconducting equipment cooling device, in which the superconducting equipment cooling device includes a cryocooler that cools superconducting equipment, the method comprising:
receiving a selection of a plurality of performance parameters of the cryocooler by a user; and
controlling a plurality of operation parameters of the cryocooler that affect the selected plurality of performance parameters.
